(19) United States
(12) Patent Application Publication
(10) Pub. No.: US 2004/0059723 A1
(43) Pub. Date: Mar. 25, 2004

(54) Information service search support apparatus, information service search apparatus, and information service search method

(76) Inventors: Tetsuo Hasegawa, Tokyo (JP); Shinichi Nagano, Yokohama-shi (JP); Akihiko Ohsuga, Kawasaki-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/606,243

(22) Filed: Jun. 26, 2003

(30) Foreign Application Priority Data
Jun. 27, 2002 (JP) 2002-188340

(51) Int. Cl. G06F 7/00

(52) U.S. Cl. 707/3

(57) ABSTRACT

The result of the search from a temporary search section is given to a search condition item extracting section. The search condition item extracting section extracts registered information items for the retrieved Web service from a registry. The search condition item extracting section classifies the retrieved domains and checks the frequency of keywords, input and output items, and input and output restrictions. A condition item inquiry section transmits to the agent requesting the search the extracted information items in the form of a list of search condition items on the basis of such pieces of information as classification and frequency. As a result, the agent can make a re-search by specifying effective search keys and search values.

### CROSS-REFERENCE TO RELATED APPLICATIONS

This application is based upon and claims the benefit of priority from the prior Japanese Patent Application No. 2002-188340, filed Jun. 27, 2002, the entire contents of which are incorporated herein by reference.

### BACKGROUND OF THE INVENTION

1. Field of the Invention

This invention relates to an information service search support apparatus, an information service search apparatus, and an information service search method which are used for searching for information services, such as Web services.

2. Description of the Related Art

In recent years, the Internet has been popularized. On the Internet, a hypertext document system called WWW (World Wide Web, or just “Web”) is used. Use of a Web browser enables the user to read documents open to the public on the Internet by means of hypertext functions.

To search for a tremendous number of documents (hereinafter, referred to as Web pages) open on the Internet, Web page search engines are used. When a word or a phrase in a Web page is given as a search key to a Web page search engine, the URLs (Uniform Resource Locators) for Web pages including the word or phrase are returned.

This type of technique has been disclosed in, for example, Jpn. Pat. Appln. KOKAI Publication No. 2000-76279. The technique disclosed in the publication is such that a plurality of feature keywords are extracted from the retrieved Web page, the Web pages are classified on the basis of the feature keywords, and the user is prompted to search for the Web page again.

In recent years, the Web service technique for making it possible to access programmable application components by use of various Web protocols complying with the Internet standard has been developed and put to practical use. The Web service technique, which is an Internet-based distributed system, enables various information services to be used via the Internet.

Unlike the various distributed object techniques in present use, the Web service technique makes the interface common to the outside world, thereby enabling a great variety of information services on the Internet to be used flexibly. For instance, in “XML Web services” proposed by Microsoft Corporation (R), XML (extensible Markup Language) is fully employed as an interface with the outside world. In addition, as a data access protocol, SOAP (Simple Object Access Protocol), a messaging protocol standard, is used.

In various types of distributed object techniques, the existence of objects is known. In contrast, in Web service techniques, the existence of objects is unknown. Thus, the technique for searching for the necessary service from an enormous number of information services on the network is important. To search for Web services, Web service search engines have been developed. A program for searching for information by use of a Web service search engine is known as a Web service matchmaker.

In Web page search engines, since Web pages, search objects, are documents, Web page search engines can use words and phrases included in a search object as search keys. However, in Web service search engines, since search objects are information services on the network, the information included in the search objects cannot be set directly as search keys.

To avoid the problem, Web service matchmakers have a registry in which information services opened on the network are to be registered. In the registry, various information items incidental to information services are registered. The Web service matchmakers search for information services with the registered individual information item as search keys.

An agent on the network wanting a search of information services, such as Web services makes a request to a Web service matchmaker on the network for a search. This request is made by setting a value (search value.) in each search key. Information items acting as search keys include service names, service domains, input and output items, various restrictions on the input and output, and comments. The Web service matchmaker collates the search value for the specified search key with the contents of the registry and returns information about the Web service whose search value has agreed with the contents. Here, the agent is an object existing hypothetically on the network.

As described above, Web page search engines use words and phrases in documents as search keys, whereas Web service search engines use a plurality of information items as search keys. That is, Web page search engines use search keys of one type, whereas Web service search engines use a plurality of kinds of search keys.

The Web service search engine searches for an information service on the basis of the agreement or disagreement of the values for the search keys. Thus, when the search conditions are not set suitably, a large number of results of the search including information services different from the desired information services may be returned to the user. In addition, the result of the search not containing the desired information services may be returned to the user.

The number of items included in the information items acting as the search keys for individual services is much lower than the number of documents constituting a Web page. Furthermore, there may be a case where the user cannot know the information items to be specified in a search request. Thus, when Web services are searched for, it is difficult to specify information items suitably. Moreover, it is difficult to set a value for a search key suitably.

As described above, with the existing techniques, it is very difficult to make a suitable search request to a Web service search engine. This leads to the disadvantage of being difficult to search for information services efficiently.

### BRIEF SUMMARY OF THE INVENTION

The object of the present invention is to provide an information service search support apparatus, an information service search apparatus, and an information service search method which are capable of making search requests more effective and searching for information services efficiently.

According to an aspect of the present invention, there is provided an information service search support apparatus comprising: a temporary search unit configured to, when receiving from an agent a search request to search for a desired information service from a plurality of information services existing on a network, search a registry in which the plurality of information services are registered in such a manner that the plurality of information services correspond to information items and item values corresponding to the contents of each service; and search condition item extracting means for extracting at least one of an information item related to the information service retrieved by the temporary search unit and a value of the information item, from the registry and notifying the agent of at least of the information item extracted and the value extracted, together with the result of the search made by the temporary search unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention..

FIG. 1 is a block diagram of an information service search apparatus according to a first embodiment of the present invention;

FIG. 2 is a diagram to help explain an example of an initial search request;

FIG. 3 is a diagram to help explain an example of Web services acquired by a temporary search;

FIG. 4 is a diagram to help explain the search condition items extracted by the search condition item extracting section 4 of FIG. 1;

FIG. 5 is a diagram to help explain an example of a presentation on the basis of the condition item presentation information;

FIG. 6 is a diagram to help explain a search key and a search value in requesting a re-search;

FIG. 7 is a flowchart for the processes in the individual sections;

FIG. 8 is a block diagram of an information service search apparatus according to a second embodiment of the present invention;

FIG. 9 is a diagram to help explain an example of an initial search request;

FIG. 10 is a diagram to help explain the result of a temporary search;

FIGS. 11A and 11B are diagrams to help explain examples of ontology trees;

FIG. 12 is a table listing the agreed item values in the input items;

FIG. 13 is a table listing the result of classifying categories;

FIG. 14 is a table listing the result of examining the frequency of appearance;

FIG. 15 is a table to help explain an example of a presentation on the basis of the condition item presentation information returned to the agent;

FIG. 16 is a diagram to help explain an example of re-search request;

FIG. 17 is a diagram to help explain the numbers corresponding to the item values for the input items in each Web service;

FIG. 18 is a table listing the result of determining the qualification for Web services; and

FIG. 19 is a flowchart for the processes in the individual sections.

### DETAILED DESCRIPTION OF THE INVENTION

Hereinafter, referring to embodiments of the present invention will be explained in detail.

(First Embodiment)

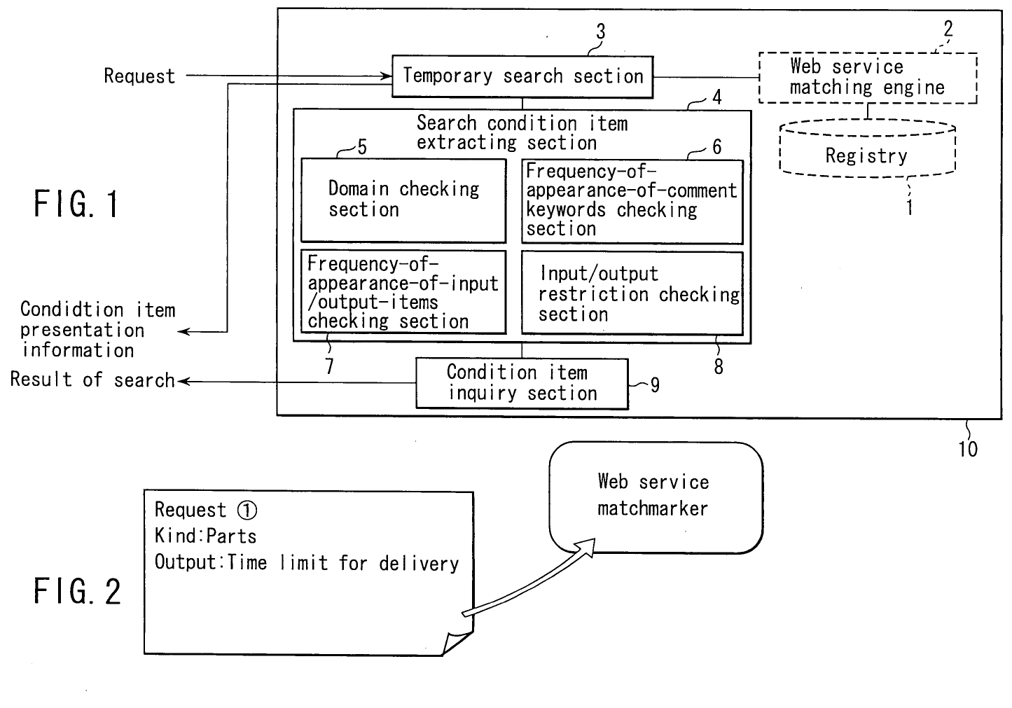

FIG. 1 is a block diagram of an information service search apparatus according to a first embodiment of the present invention.

In the first embodiment, Web services will be explained as an example of information services distributed on a network. A Web service matchmaker 10 in FIG. 1 is connected to a network (not shown), such as the Internet.

In a registry 1, various Web services on the network are registered. That is, in the registry 1, a plurality of information items for specifying the individual Web services are stored in such a manner that they correspond to the respective Web services.

For example, in the case of a Web service that provides a program for making sure of the time limit for delivery as an information service, service names, service domains, input and output items, various restrictions on the input and output, comments, and others are registered in the registry 1.

A service name is a name given to a service by the Web service provider. A service domain is information indicating the domain for the service. The input and output items are data items to be inputted when a program is used. The output items are output data obtained as a result of using the program. The input and output item restrictions are restrictions on the data inputted to the program and restrictions on the data outputted from the program.

The user can get the result of searching for the desired Web service by specifying an information item in the registry 1 as a search condition item (or search key).

Specifically, the agent wanting a search of a Web service gives a request for a Web service search to the Web service matchmaker of FIG. 1 via the network. By specifying a search value (the contents of the information item (item value)) for each search key with the information item as a search key, a request for a search is given. According to the received request, the Web service matchmaker outputs the result of searching for the Web service.

A temporary search section 3 gives the search value for each search key to a Web service matching engine 2. Using the information items registered in the registry 1 as search keys, the Web service matching engine 2 determines whether the search value inputted for each search key agrees or disagrees with the item value of each information item registered in the registry 1. The Web service matching engine 2 outputs information for accessing the Web service for which the search value of the search key agrees with the item value to the temporary search section 3 as the result of the search.

The temporary search section 3 sends the result of the search from the Web service matching engine 2 onto the Internet. In the first embodiment, when the result of the search from the Web service matching engine 2 specifies a larger number of Web services than a specified number of Web services, the temporary search section 3 outputs the result of the search also to a search condition item extracting section 4.

The search condition item extracting section 4 extracts an information item stored in the registry 1 as a search condition item. The search condition item extracting section 4 outputs the extracted search condition item to a condition item inquiry section 9. On the basis of the search condition item extracted by the search condition item extracting section 4, the condition item inquiry section 9 creates condition item presentation information to be presented to the agent who has requested the search and sends it onto the Internet.

The condition item presentation information is information for displaying information items capable of being specified as search keys on the screen of the agent who is requesting the search. Referring to the information displayed on the screen, the agent can specify a search key to be specified and a much more effective value for the search key.

Furthermore, in the first embodiment, the search condition item extracting section 4 subjects information items in the registry 1 to a filter process, thereby creating search condition items suitable for the search.

The search condition item extracting section 4 includes a domain checking section 5, a frequency-of-appearance-of-comment-keywords checking section 6, a frequency-of-appearance-of-input/output-items checking section 7, and an input/output restriction checking section 8.

The domain checking section 5 subjects the information item “Domain” registered in the registry 1 to a filtering process. That is, the domain checking section 5 classifies the information item “Domain” by category and outputs the result of the classification to the condition item inquiry section 9, thereby making it possible to show what domain categories can be included in “Domain”.

The frequency-of-appearance-of-comment-keywords checking section 6 subjects “Comment” to a filtering process. That is, the frequency-of-appearance-of-comment-keywords checking section 6 checks the frequency of appearance of keywords appearing in comments and outputs the result of checking the frequency of appearance of keywords to the condition item inquiry section 9. As a result, the condition item inquiry section 9 presents the keywords whose frequency exceeds a specified number to the agent as the result of checking the comments.

The frequency-of-appearance-of-input/output-items checking section 7 subjects “Input/output item” to a filtering process. That is, the frequency-of-appearance-of-input/output-items checking section 7 checks the frequency of appearance of each item value in the input and output items and outputs the result of the checking to the condition item inquiry section 9. As a result, the condition item inquiry section 9 presents the item values whose frequency exceeds a specified number to the agent as the result of checking the input and output items.

The input/output restriction checking section 8 subjects “Input/output item restrictions” to a filtering process. That is, the input/output restriction checking section 8 checks the frequency of appearance of restrictions on each input/output item and outputs the result of the checking to the condition item inquiry section 9. As a result, the condition item inquiry section 9 presents the restrictions whose frequency exceeds a specified number to the agent as the result of checking the input and output items.

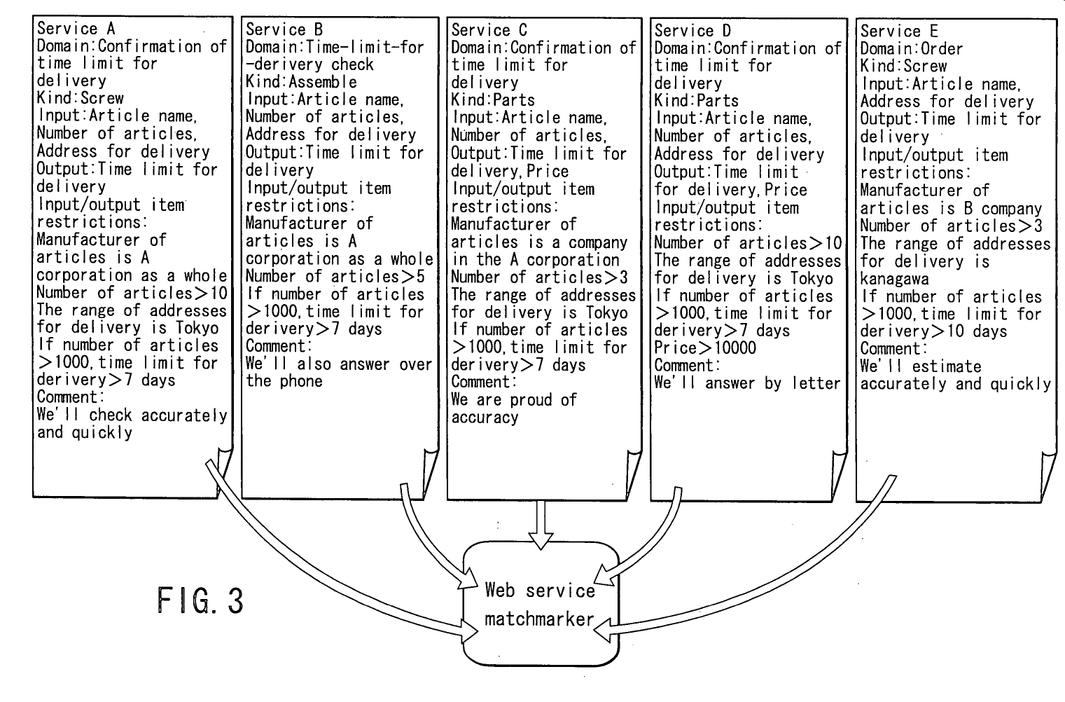

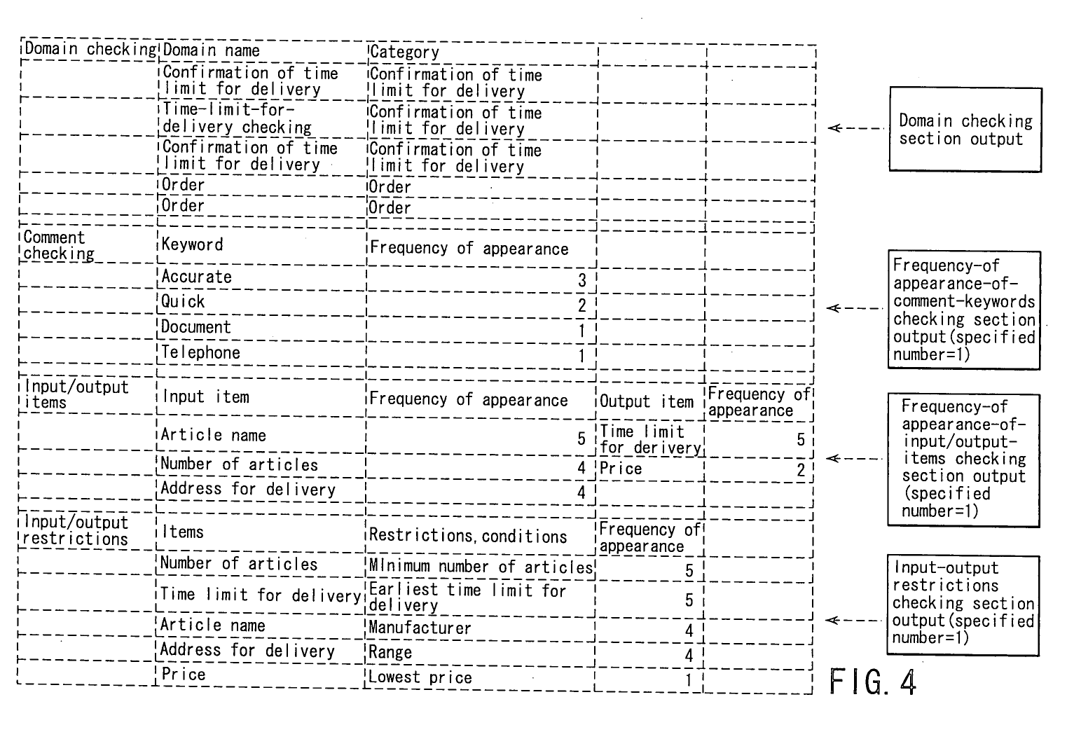

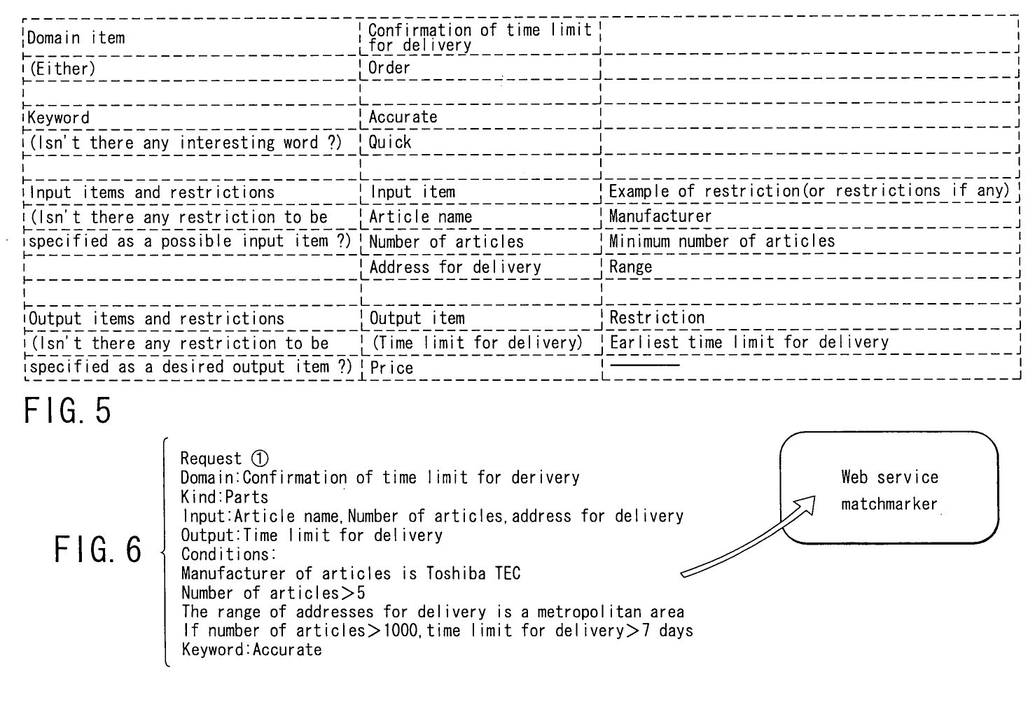

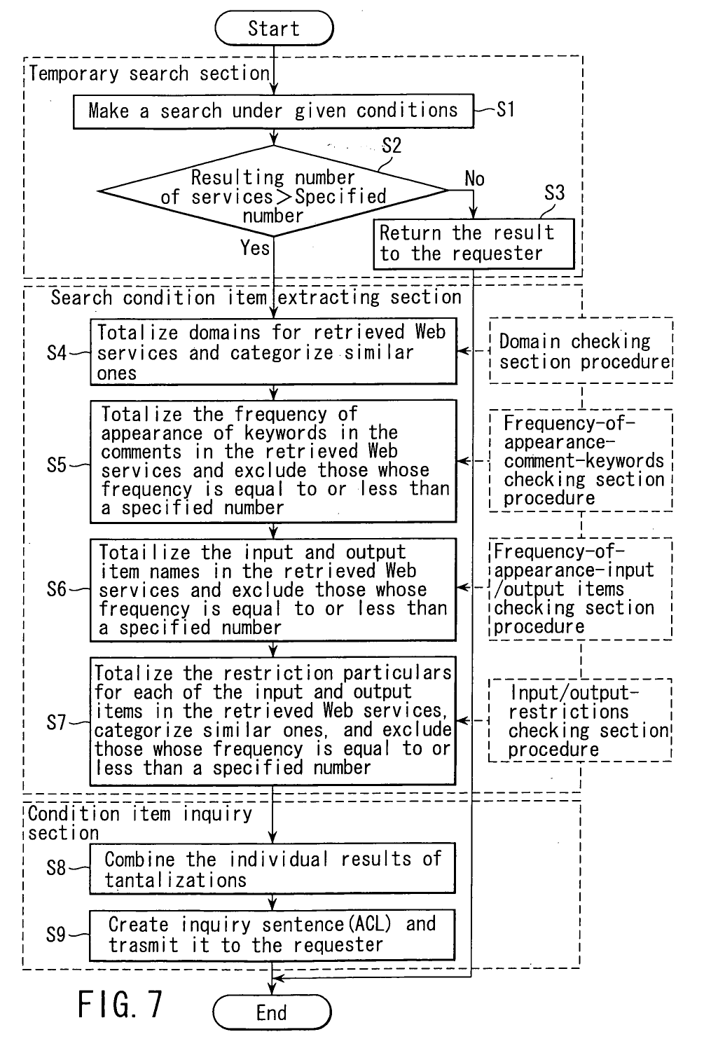

The operation of the first embodiment will be explained by reference to FIGS. 2 to 7. FIG. 2 is a diagram to help explain an example of an initial search request. FIG. 3 is a diagram to help explain an example of Web services acquired by a temporary search. FIG. 4 is a diagram to help explain the search condition items extracted by the search condition item extracting section 4 of FIG. 1. FIG. 5 is a diagram to help explain an example of a presentation on the basis of the condition item presentation information. FIG. 6 is a diagram to help explain a search key and a search value in requesting a search again. FIG. 7 is a flowchart for the processes in the individual sections.

In the explanation below, it is assumed that various Web services on the Internet have been registered in the registry 1. In addition, it is assumed that a specific agent on the Internet searches for a Web service to use a program for making sure of the time limit for delivery of goods, one of the Web services.

For instance, suppose the agent uses a Web service to make sure of the time limit for delivery of a certain part. In this case, as shown in FIG. 2, kind and output are specified as search condition items (search keys), a part is set as a search value in the kind search key, and the time limit is set as a search value in the output search key. As a result of setting these values, a search request is created.

The search request is given to the Web service matchmaker 10 of FIG. 1 via the network. The temporary search section 3 of the Web service matchmaker 10 gives the received search request to the Web service matching engine 2. According to the search request, the Web service matching engine 2 searches the registry 1 in step S1 of FIG. 7.

It is assumed that the results of the search shown in FIG. 3 are obtained from the registered information in the registry 1. FIG. 3 shows that five results of the search are obtained at the search request of FIG. 2. The results of the search each show information about Web services whose service names are service A to service E, respectively. As seen from the results of the search, the information items registered in the registry 1 include the following seven items: service name, domain, kind, input, output, input/output item restrictions, and comment.

The temporary search section 3 determines whether the number of services extracted in the searching process (or the resulting number of services) is larger than a specified number (step S2). If the resulting number of services is smaller than the specified number, the temporary search section 3 makes the result of the extraction valid and transmits the result of the search as it is to the agent (step S3).

If the resulting number of services is larger than the specified number, the temporary search section 3 determines that the result of the extraction is not sufficiently valid and outputs the result of the search to the search condition item extracting section 4.

The search condition item extracting section 4 extracts information items registered in the registry 1. Furthermore, in the search condition item extracting section 4, the domain checking section 5, frequency-of-appearance-of-comment-keywords checking section 6, frequency-of-appearance-of-input/output-items checking section 7, and input/output restriction checking section 8 subject each information item to a filtering process.

In step S5, the frequency-of-appearance-of-comment-keywords checking section 6 checks the frequency of appearance of keywords appearing in the information item “Comment”. In the example of FIG. 3, services A, C, E have been registered with the item value “Accurate” in the information item “Comment”. Services A, E have been registered with the item value “Quick” in the information item “Comment”. Service D has been registered with the item value “Document” and service B has been registered with the item value “Telephone” in the information item “Comment”. That is, the frequency of appearance of “Accurate” is 3, the frequency of appearance of “Quick” is 2, the frequency of appearance of “Document” is 1, and the frequency of appearance of “Telephone” is 1.

In step S6, the frequency-of-appearance-of-input/output-items checking section 7 checks the frequency of appearance of each item value appearing in the information item “Input/output item”. In the example of FIG. 3, services A to E have been registered with the item value “Article name” as an input item, services A to E have been registered with the item name “Number of articles” as an input item, and services A, B, D, E have been registered with the item value “Address for delivery” as an input item. Services A to E have been registered with the item value “Time limit for delivery” as an output item. Services C and D have been registered with the item value “Price” as an output item. That is, the frequency of appearance of all the item values registered is 2 or more.

In step S7, the input/output restriction checking section 8 totalizes the restriction particulars appearing in the information item “input/output restrictions” and classifies the results by similar category. In the example of FIG. 3, only one kind of restriction has appeared in each item value of the input and output items. In the example of FIG. 3, services A to E have been registered with the item value “Minimum number” in the information item “Input/output restrictions”. Services A to E have been registered with the item value “Early time limit for delivery”, services A to C and E have been registered with the item value “Manufacturer”, services A, C to E have been registered with the item value “Range”, and service D has been registered with the item value “Minimum price” in the information item “Input/output restrictions”. That is, only the frequency of appearance of “Minimum price” is 1 and the frequency of appearance of other items is 2 or more.

The search condition item extracting section 4 outputs to the condition item inquiry section 9 the results of the totalization at the domain checking section 5, frequency-of-appearance-of-comment-keywords checking section 6, frequency-of-appearance-of-input/output-items checking section 7, and input/output restriction checking section 8 and the result of the filtering process. In step S8, the condition item inquiry section 9 combines the results of the tantalizations to create an inquiring and questioning sentence (ACL) (Agent Communication Language) and sends the questioning sentence as condition item presentation information to the requester. ACL is a known inter-agent interactive language on the basis of the Speech-Act Theory.

In this case, the condition item inquiry section 9 organizes the input and output items and the restrictions corresponding to the input and output items and classifies the inputs and outputs as shown in FIG. 5. To the agent requesting the search, for example, the search condition items of FIG. 5 are shown. FIG. 5 shows the states corresponding to FIG. 4. In FIG. 5, at the agent who has made a request for search, the information item “Domain” has been registered with the item values “Confirmation of time limit for delivery” and “Order”. Furthermore, it is seen that “Accurate” and “Quick” have been registered as keywords. Similarly, concerning the input items and restrictions and the output items and restrictions, the condition items obtained from FIG. 4 are shown.

Referring to FIG. 5, the agent requesting the search can set effective search conditions for narrowing the possibilities sufficiently to the desired Web service. For instance, as shown in FIG. 6, the agent specifies “Confirmation of time limit for delivery” as the domain item, “Parts” as the kind item, “Article name”, “Number of articles”, and “Address for delivery” as the input item. Moreover, the agent specifies “Time limit for delivery” as the output item, “Manufacturer of the article is (a) company in A corporation” as the condition, and “Five” as the number item. In addition, the agent specifies a metropolitan area as the range of addresses for delivery, then “If number of articles>1000, time limit for delivery>7 days”, and “Accurate” as a keyword.

The re-search request of the agent is given to the Web service matchmaker 10 of FIG. 1 via the Internet. The temporary search section 3 supplies the received search condition items together with the values to the Web service matching engine 2. In this way, the Web service matching engine 2 acquires information about Web services stored in the registry 1. In the examples of FIGS. 3 to 6, only service B is obtained as the result of the search made at the re-research request.

In the re-search, too, when the resulting number of services is smaller than the specified number, the temporary search section 3 returns the result of the search as it is to the agent requesting the re-search. When the resulting number of services is larger than the specified number, the temporary search section 3 outputs the result of the search to the search condition item extracting section 6. In this case, the search condition item extracting section 6 changes the setting of the specified number and further narrows the conditions. Then, the search condition item extracting section 6 outputs the result of the filtering process of information items to the condition item inquiry section 9.

From this point on, similar operations are repeated, thereby enabling the valid search condition items to be set.

As described above, in the first embodiment, the Web service matchmaker 10 extracts information items set in the registry 1 and sends the extracted information items as presentation information about the search condition items to the searcher. Furthermore, the Web service matchmaker 10 subjects the information items to a specific filtering process in terms of totalizing or the frequency of appearance and sends the result as presentation information about the search condition items to the searcher.

By such processes, the agent, or the searcher, can easily know a search key and a search value effective in searching the registry 1 on the basis of the presentation information. Thus, it is possible to improve the Web service searching efficiency greatly.

In the first embodiment, concerning the frequency of appearance, Web services whose frequency of appearance is equal to or less than the specific number are excluded. The present invention is not limited to this. For instance, the criterion for selecting Web services to be excluded may be the one for selecting Web services whose frequency of appearance is relatively small. Alternatively, Web services are excluded except for those whose frequency of appearance is in the range of the largest to a lower value in a consecutive specific number.

In information services, the item values for information items may be set as information items with item values specifiable as search values. Even when the information items have a hierarchical structure as described above, the first embodiment can be applied.

(Second Embodiment)

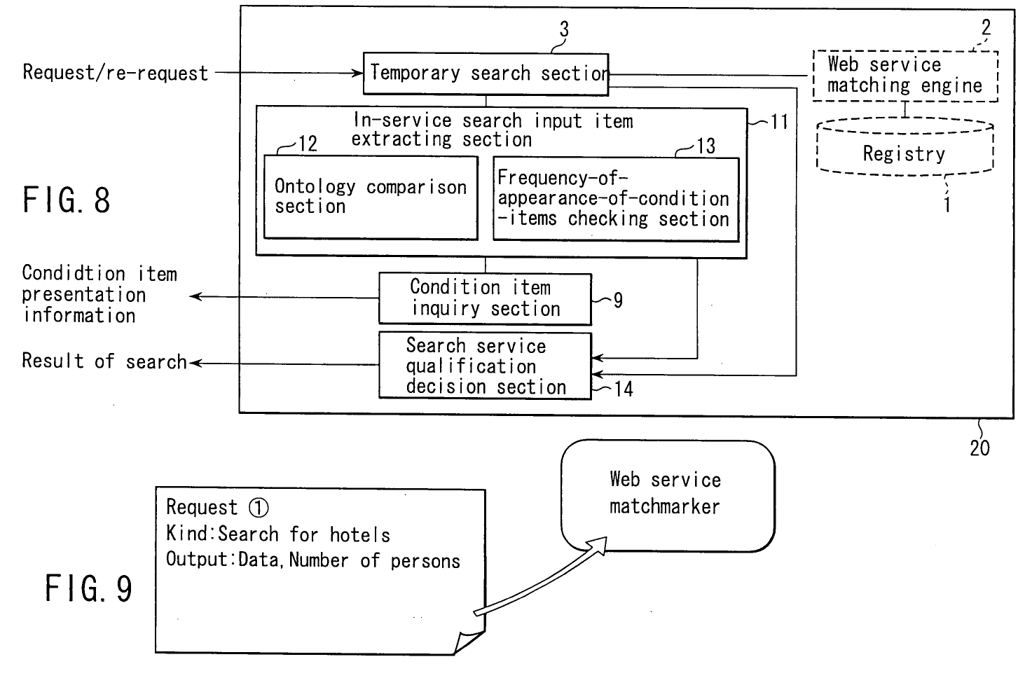

FIG. 8 is a block diagram of an information service search apparatus according to a second embodiment of the present invention. In FIG. 8, the same parts as those in FIG. 1 are indicated by the same reference numerals and explanation of them will be omitted.

In the registry 1, information items corresponding to information services to be searched for are stored. That is, the contents (or item values) of the information items can be inferred to some extent according to the types of information services to be searched for. For instance, in the case of the aforementioned time-limit-for-delivery confirmation service, only two item values, “Time limit for delivery” and “Price” exist as output items in FIG. 3.

However, when an information service to be searched for is a search service itself, a searching method may differ from one information service search engine to another. Thus, the item values for the information items stored in the registry 1 may be in a wide range.

The second embodiment deals with a case where an information service to be searched for is a search service. The second embodiment extracts the item values for information items and returns them to the agent requesting the search, thereby improving the searching efficiency remarkably.

As described above, the information items have a hierarchical structure. For instance, the item values for a specific information item may be set as an information item having an item value in the layer below. In the second embodiment, for the sake of explanation, information items excluding those in the highest layer are assumed to be item values.

A Web service matchmaker 20 of the second embodiment has an in-service search input item extracting section 11 in place of the search condition item extracting section 4. It further has a search service qualification decision section 14.

The in-service search input item extracting section 11 includes an ontology comparison section 12 and a frequency-of-appearance-of-condition-items checking section 13. When receiving the result of the search from the temporary search section 3, the ontology comparison section 12 refers to an ontology tree (dictionary) in the field corresponding to the domain of the information service corresponding to the result of the search and classifies the information items by category. Furthermore, the frequency-of-appearance-of-condition-items checking section 13 checks the frequency of appearance of item values in each information item.

The in-service search input item extracting section 11 outputs to the condition item inquiry section 9 the result of the classification by category by the ontology comparison section 12 and the result of checking the frequency of appearance of item values in each information item by the frequency-of-appearance-of-condition-items checking section 13. On the basis of these results of the checking, the condition item inquiry section 9 creates condition item presentation information.

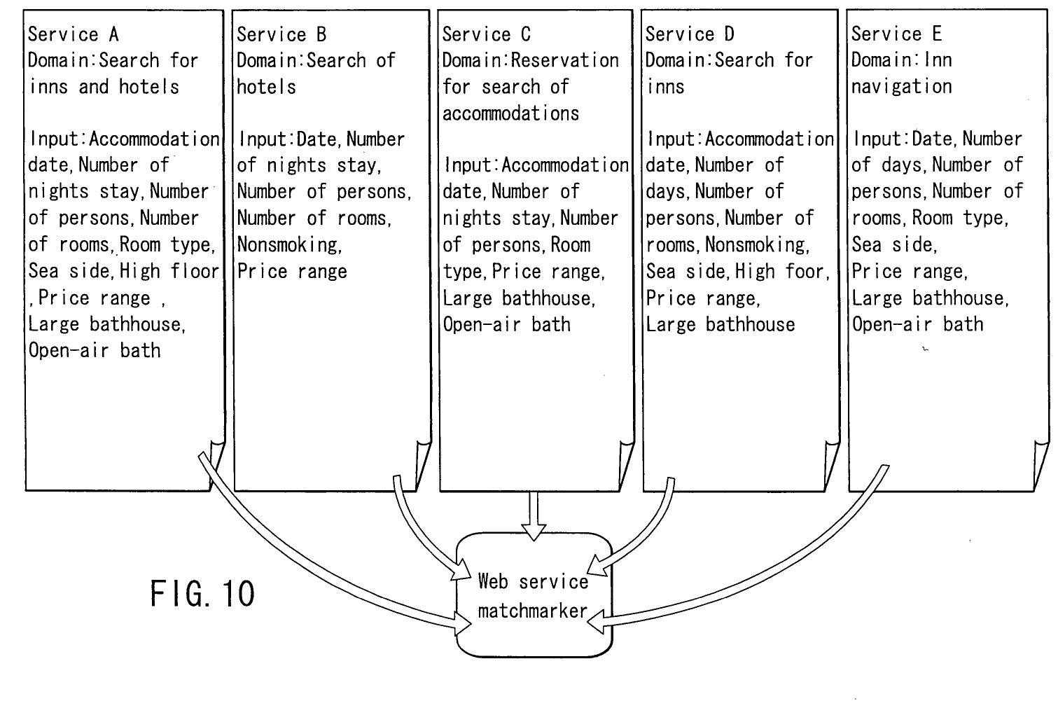

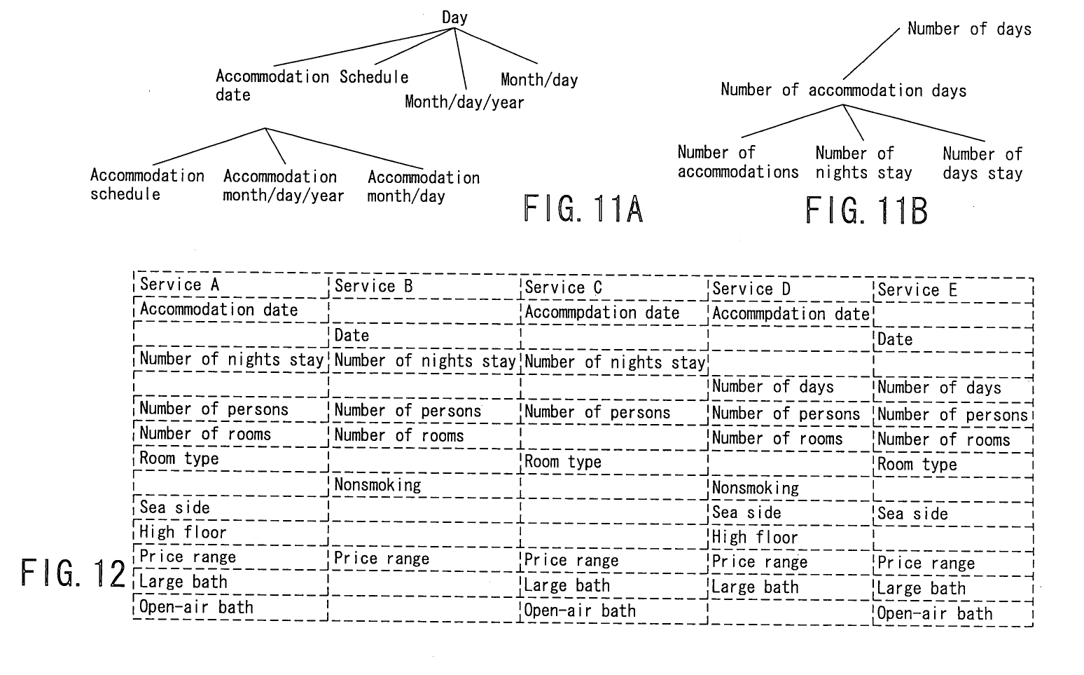

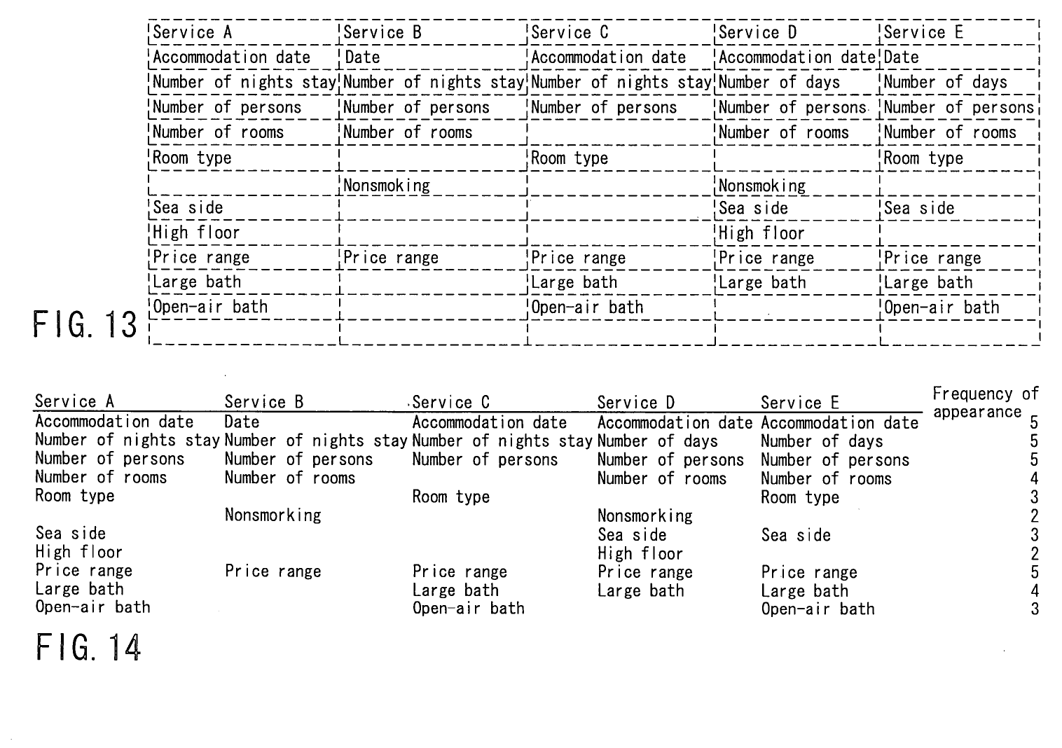

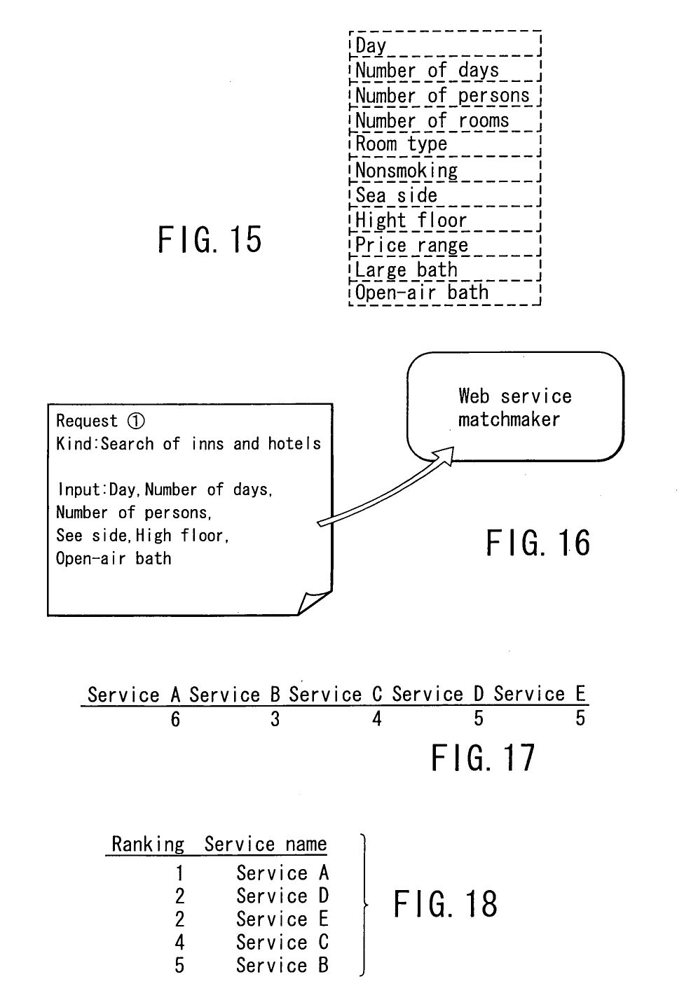

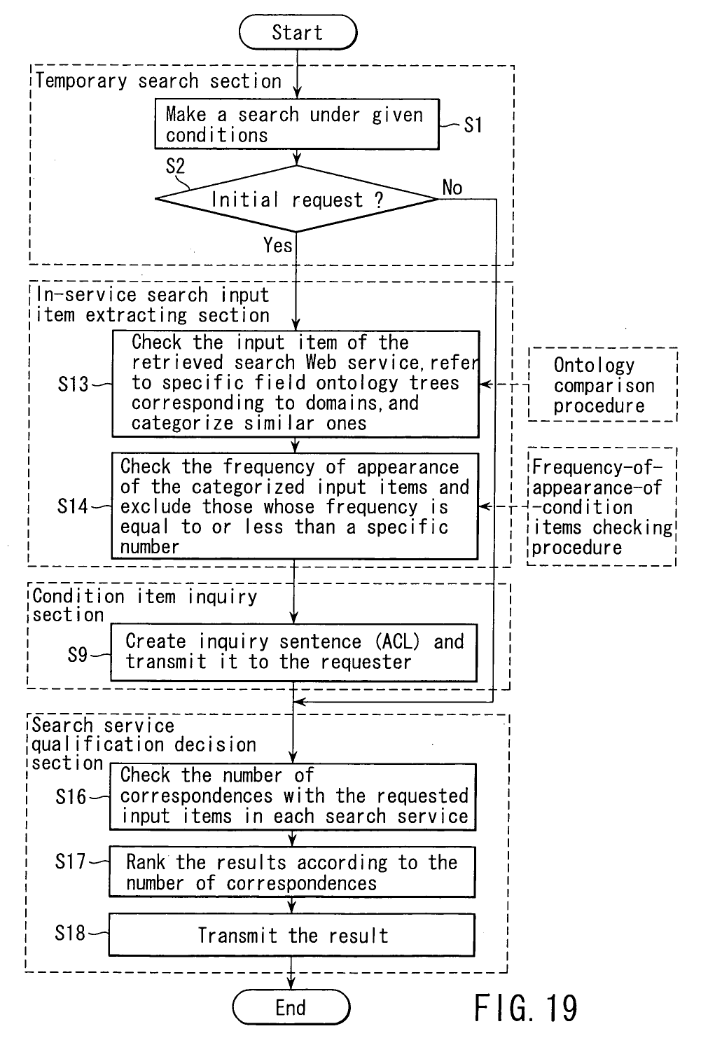

The operation of the second embodiment will be explained by reference to FIGS. 9 to 19. FIG. 9 is a diagram to help explain an example of an initial search request. FIG. 10 is a diagram to help explain the result of a temporary search. FIG. 11 is diagrams to help explain examples of ontology trees. FIG. 12 is a table listing the item values agreed in the input items. FIG. 13 is a table listing the result of classifying categories. FIG. 14 is a table listing the result of checking the frequency of appearance. FIG. 15 is a table to help explain an example of a presentation on the basis of the condition item presentation information returned to the agent. FIG. 16 is a diagram to help explain an example of re-search request. FIG. 17 is a diagram to help explain the numbers corresponding to the item values for the input items of the individual Web services. FIG. 18 is a table listing the result of determining the qualification for Web services. FIG. 19 is a flowchart for the processes in the individual sections.

In the explanations below, consider a case where an information service providing an accommodation search services is searched for. It is assumed that accommodation search services are registered in the registry 1.

To use accommodation search services, the agent requests an initial search shown in FIG. 9. That is, the agent who wants to search for search services specifies the kind and input as search condition items (search keys) as shown in FIG. 9, sets a hotel search as a search value in the kind search key and a date and the number of persons as search values in the input search key.

The search request is given to the Web service matchmaker 30 of FIG. 8 via the network. The temporary search section 3 of the Web service matchmaker 20 gives the received search request to the Web service matching engine 2. According to the search request, the Web service matching engine 2 searches the registry 1 in step S1 of FIG. 19.

Suppose the result of the search shown in FIG. 10 has been obtained from the registered information in the registry 1. FIG. 10 shows that five results of the search have been obtained at the search request of FIG. 9. The individual results of the search show information about the Web services with the service names, service A to service E, respectively. As seen from the results of the search, the information items registered in the registry 1 are only the following three items: service names, domains, and input items. However, various item values have been registered in the input item. The kinds of item values differ from service to service.

For example, when the agent uses a Web service in service A, it is seen that hotels can be searched for on the basis of the presence or absence of “Open-air bath”. In addition, when the agent uses a Web service in service B, it is seen that hotels where “Nonsmoking” can be specified can be searched for.

FIG. 12 shows all of the item values for the input items in the results of the search from the temporary search section 3. As shown in FIG. 12, in services A to E, unique item values are set as the input item.

The result of the search at the temporary search section 3 is given to the in-service search input item extracting section 11. In the in-service search input item extracting section 11, the ontology comparison section 12 classifies the individual item values for the input items by similar category (step S12). In this process, the ontology comparison section 12 uses a specific field ontology tree.

FIG. 11 shows examples of specific field ontology trees used in the ontology comparison section 12. FIG. 11A shows that setting is done in such a manner that “Month/day-of-month”, “Month/day-of-month/year”, “Schedule”, and “Accommodation date” have the same meaning as that of “Date”. FIG. 11A also shows that setting is done in such a manner that “Accommodation schedule”, “Accommodation month/day-of-month/year”, “Accommodation month/day-of-month” have the same meaning as that of “Accommodation date”.

Similarly, FIG. 11B shows that setting is done in such a manner that “Number of accommodation days” has the same meaning as that of “Number of days”. FIG. 11B also shows that setting is done in such a manner that “Number of accommodations”, “Number of staying nights”, and “Number of staying days” have the same meaning as that of “Number of accommodation days”.

When the ontology trees as shown in FIG. 11 are used, FIG. 13 shows category classification applied to the result of the search in FIG. 10. For instance, when the ontology tree of FIG. 11A is used, it is determined that, of the input items of FIG. 10, the item value “Accommodation date” in services A, C, and D and the item value “Date” in services B and E are classified into the same category. In addition, when the ontology tree of FIG. 11A is used, it is determined that, of the input items of FIG. 10, the item value “Number of accommodations” in services A to C and the item value “Number of days” in services D and E are classified into the same category.

In step S13, the frequency-of-appearance-of-condition-items checking section 13 checks the frequency of appearance of each item value in the input item and extracts an item value whose frequency of appearance is larger than a specified number (frequency of appearance).

FIG. 14 shows the result of checking the frequency of appearance of item values by the frequency-of-appearance-of-condition-items checking section 13. The contents of FIG. 14 correspond to the result of the search of FIG. 10. In the example of FIG. 10, the frequency of appearance of each of all the items of all the services is larger than 1.

On the basis of the list of the item values for the input items by the ontology comparison section 12 and the result of checking the frequency of appearance of item values by the frequency-of-appearance-of-condition-items checking section 13, the condition item inquiry section 9 creates a re-search request in the form of an inquiry ACL message. Then, the condition item inquiry section 9 transmits the message to the requester (step S9). In this case, the condition item inquiry section 9 sets the specified number of the frequency of appearance to 1 and uses only item values whose frequency of appearance is larger than 1.

Use of the ACL message from the condition item inquiry section 9 causes the search condition items shown in, for example, FIG. 15 to be shown to the agent requesting the search. FIG. 15 shows a state corresponding to FIGS. 13 and 14.

FIG. 15 shows that the agent requesting the search can use as search values settable in the input item, “Day”, “Number of days”, “Number of persons”, “Number of rooms”, “Room type”, “Nonsmoking”, “Sea side”, “High floor”, “Price range”, “Large bathhouse”, and “Open-air bath”.

Referring to the presentation of FIG. 15, the agent requesting the search sets search values considered more effective as the specified search condition and carries out the search requesting process. It is assumed that, in searching again, the agent requesting the search makes a search request shown in, for example, FIG. 16. In the search request of FIG. 16, “Day”, “Number of days”, “Number of persons”, “Sea side”, “High floor”, and “Open-air bath” have been specified as the input item. That is, the agent can find a search engine capable of searching for accommodations by specifying “Day”, “Number of days”, “Number of persons”, “Sea side”, “High floor”, and “Open-air bath” as search conditions.

The re-search request is given to the temporary search section 3. The temporary search section 3 causes the Web service matching engine 2 to search again on the basis of the re-search request. The result of the re-search is also outputted to the a search service qualification decision section 14 via the temporary search section 3. The search service qualification decision section 14 checks the number of agreements (correspondences) between the item values set in the input item in the service in the result of the search and the search values in the re-search request (step S16). FIG. 17 shows the numbers of correspondences.

For example, in service A of FIG. 10, all of the six set search values are included in the item values in the input item. In service B, three value items, “Date (day)”, “Number of accommodations (Number of days)”, and “Number of persons” in the input item agree with the search values. The search service qualification decision section 14 sorts the results of the checking in FIG. 17 in descending order of the number of correspondences (step S17). FIG. 18 shows the result of the sorting. The search service qualification decision section 14 outputs a list of the result of the sorting to the agent making a request (step S18). The list of the result of the sorting includes not only service names but also information for accessing the services.

Referring to the received list of the result of the sorting, the agent requesting the search can find that the Web service with the largest number of set search values is service A.

As described above, with the second embodiment, as when a search engine on the network is searched for, even when the search values for the information items become diversified, it is possible to let the agent requesting the search know effective values as search values. Thus, it is possible to improve the Web service searching efficiency..

In the second embodiment, the search service qualification decision section 14 determines the qualification of a search service only at the time of a re-search request. This invention is not limited to this. For instance, the list of the result of the sorting at a search request may be transmitted to the searcher even at a first search request.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information service search support apparatus comprising:
a temporary search unit configured to, when receiving from an agent a search request to search for a desired information service from a plurality of information services existing on a network, search a registry in which said plurality of information services are registered in such a manner that said plurality of information services correspond to information items and item values corresponding to the contents of each service; and
search condition item extracting means for extracting at least one of an information item related to the information service retrieved by the temporary search unit and a value of the information item, from the registry and notifying the agent of at least of the information item extracted and the value extracted, together with the result of the search made by the temporary search unit.

2. The information service search support apparatus according to claim 1, wherein the search condition item extracting means classifies, by common category, the information item names and/or item values related to the information service retrieved by the temporary search unit and notifies the agent of the result.

3. The information service search support apparatus according to claim 2, wherein the search condition item extracting means uses ontology trees to classify, by common category, the information item names and/or item values related to the information service retrieved by the temporary search unit.

4. The information service search support apparatus according to claim 2, wherein the search condition item extracting means classifies, by the frequency of appearance, the information item names and/or item values classified by category and notifies the agent of the result.

5. The information service search support apparatus according to claim 4, wherein the search condition item extracting means determines the qualification as a search condition item of each of the information item names and/or item values classified by the frequency of appearance for a search condition, on the basis of its frequency of appearance and notifies the agent of the result.

6. An information service search apparatus for searching for a desired information service from a plurality of information services existing on a network, comprising:
an information service search support section; and
a registry in which said plurality of information services are registered in such a manner that said plurality of information services correspond to information items and item values corresponding to the contents of each service, wherein
the information service search support section includes
a temporary search unit configured to, when receiving from an agent a search request to search for the desired information service, search the registry; and
search condition item extracting means for extracting at least one of an information item related to the information service retrieved by the temporary search unit and a value of the information item, from the registry and notifying the agent of at least of the information item extracted and the value extracted, together with the result of the search made by the temporary search unit.

7. The information service search apparatus according to claim 6, wherein the search condition item extracting means classifies, by common category, the information item names and/or item values related to the information service retrieved by the temporary search unit and notifies the agent of the result.

8. The information service search apparatus according to claim 7, wherein the search condition item extracting means uses ontology trees to classify, by common category, the information item names and/or item values related to the information service retrieved by the temporary search unit.

9. The information service search apparatus according to claim 7, wherein the search condition item extracting means classifies, by the frequency of appearance, the information item names and/or item values classified by category and notifies the agent of the result.

10. The information service search apparatus according to claim 9, wherein the search condition item extracting means determines the qualification as a search condition item of each of the information item names and/or item values classified by the frequency of appearance for a search condition, on the basis of its frequency of appearance and notifies the agent of the result.

11. An information service search method of searching for a desired information service from a plurality of information services existing on a network, comprising:
a first step of, when receiving from an agent a search request to search for the desired information service, searching, on the basis of the search request, a registry in which said plurality of information services are registered in such a manner that said plurality of information services correspond to information items and item values corresponding to the contents of each service; and
a second step of extracting at least one of an information item related to the information service retrieved in the first step and a value of the information item, from the registry and notifying the agent of at least of the information item extracted and the value extracted, together with the result of the search in the first step.

12. The information service search method according to claim 11, wherein the second step is a step of classifying, by common category, the item values for the information items related to the information service retrieved in the first step and notifying the agent of the result.

13. The information service search method according to claim 12, wherein the second step is a step of using ontology trees to classify, by common category, the item values for the information items related to the information service retrieved in the first step.

14. The information service search method according to claim 12, wherein the second step includes a third step of classifying, by the frequency of appearance, the keywords included in the item values classified by category and notifying the agent of the result.

15. The information service search method according to claim 14, wherein the second step is a step of determining the qualification of each of the keywords classified by the frequency of appearance in the third step, on the basis of its frequency of appearance and notifying the agent of the result.
